(19) United States
(12) Patent Application Publication
(10) Pub. No.: US 2006/0126489 A1
(43) Pub. Date: Jun. 15, 2006

(54) Transmitter diversity method for ofdm system

(76) Inventors: Xuemei Quyang, Ossining, NY (US); Monisha Ghosh, Chappaqua, NY (US)

Correspondence Address: PHILIPS INTELLECTUAL PROPERTY & STANDARDS, P.O. BOX 3001, BRIARCLIFF MANOR, NY, 10510, US

(21) Appl. No.: 10/538,577

(22) PCT Filed: Dec. 5, 2003
(86) PCT No.: PCT/IB03/05753

§ 371 Date: Jun. 15, 2005

Related U.S. Application Data
(60) Provisional application No. 60/434,576, filed on Dec. 19, 2002.

(51) Int. Cl. H04J 11/00

(52) U.S. Cl. 370/208

(57) ABSTRACT

A transmitter (20) of an OFDM system (10) splits a data input signal into a pair of OFDM subcarrier streams (S0, S1). The transmitter further implements a cross subcarrier transmitter diversity encoding of the OFDM subcarrier streams (S0, S1). The result is a pair of encoded OFDM subcarrier stream (ES0, ES1) that are transformed into modulated transmitter signals (s₀, s₁), respectively, which are transmitted to a receiver antenna (60) via an transmitter antenna (50) and a transmitter antenna (51), respectively.

The present invention generally relates to wireless communication systems. The present invention specifically relates to orthogonal frequency division multiplexing (“OFDM”) transmitters.

As is well known, wireless communications usually experience the multipath-fading channel, which makes a reliable reception more difficult to achieve that in an additive white Gaussian noise channel. Transmitter diversity has been shown to be an effective way to combat this problem. Historically, most transmitter diversity schemes are implemented at a receiver side, which combines the signals received from multiple antenna elements in hope that the signals received from different antennae do not experience fading at the same time. The signals obtained from different antennae are combined through switch diversity, maximum ration combining, etc.

To reduce the cost of a wireless system, it is not very realistic to put several antennae at a receiver of a mobile station in a wireless communication. In this sense, transmitter diversity encoding is a better way to combat the multi-path fading channel at low cost of mobile users. A transmitter diversity encoding scheme involves an implementation of two transmitter antennas and one receiver antenna. The signal stream from the transmitter is split into two streams that are encoded prior to being transmitted by two different antennas. This transmitter diversity encoding scheme can improve the error performance, data rate, or capacity of the wireless communication system.

This transmitter diversity encoding scheme was originally developed for single carrier, time domain space coding systems. It has been proposed to implement this transmitter diversity encoding scheme in an OFDM multi-carrier system as a cross OFDM symbol transmitter diversity encoding wherein a receiver stores at least two OFDM symbols before decoding the transmitter diversity encoding. The result is a delay to the packet that can be sent to MAC layer processing. It is therefore desirable to implement a transmitter diversity encoding scheme in an OFDM multi-carrier system without having a requirement that the receiver stores at least two OFDM symbols in order to decode the transmitter diversity encoding.

The present invention addresses the shortcomings with the prior art by providing a transmitter diversity encoding technique that encodes between a pair of OFDM subcarrier streams within one OFDM symbol.

One form of the present invention is transmitter including a diversity encoding stage and an OFDM transmission stage. The diversity encoding stage splits a data input signal into a pair of OFDM subcarrier streams. The diversity encoding stage further implements a cross subcarrier transmitter diversity encoding of the OFDM subcarrier streams to thereby generate a pair of encoded OFDM subcarrier streams. The OFDM transmission stage transforms each encoded OFDM subcarrier stream into a modulated transmitter signal.

A second form of the present invention is method of operating a transmitter. First, a data input signal is split into a pair of OFDM subcarrier streams. Second, a cross subcarrier transmitter diversity encoding of the OFDM subcarrier streams is implemented to thereby generate a pair of encoded OFDM subcarrier streams. Third, each encoded OFDM subcarrier stream is transformed into a modulated transmitter signal.

The foregoing forms as well as other forms, features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

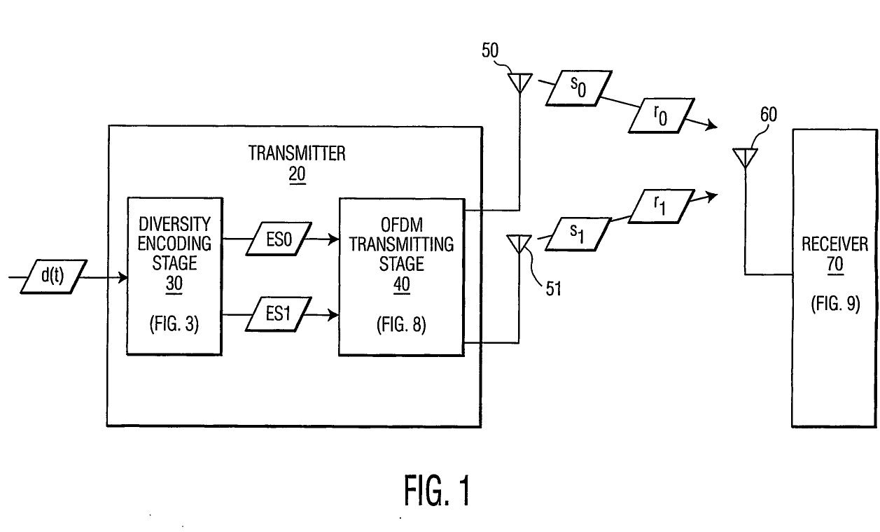

FIG. 1 illustrates a block diagram of an OFDM system in accordance with one embodiment of the present invention;

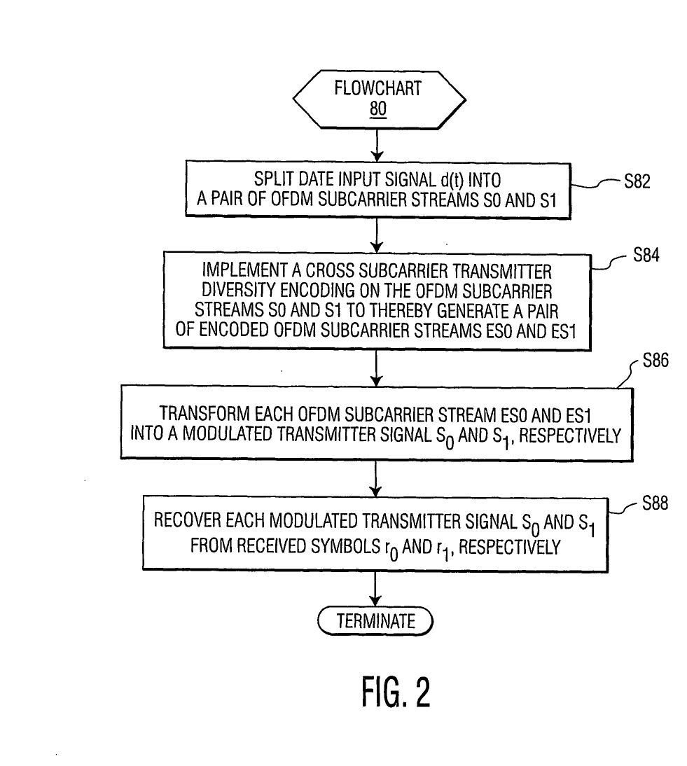

FIG. 2 illustrates a flowchart representative of an OFDM transmission method in accordance with one embodiment of the present invention;

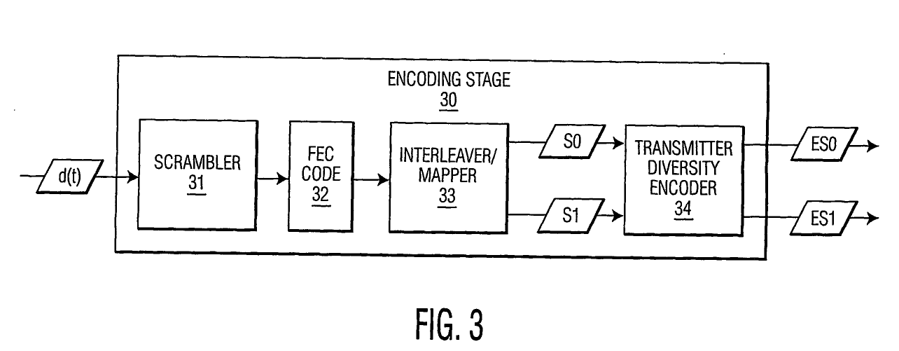

FIG. 3 illustrates a block diagram of a diversity encoding stage of the wireless communication system of FIG. 1 in accordance with one embodiment of the present invention;

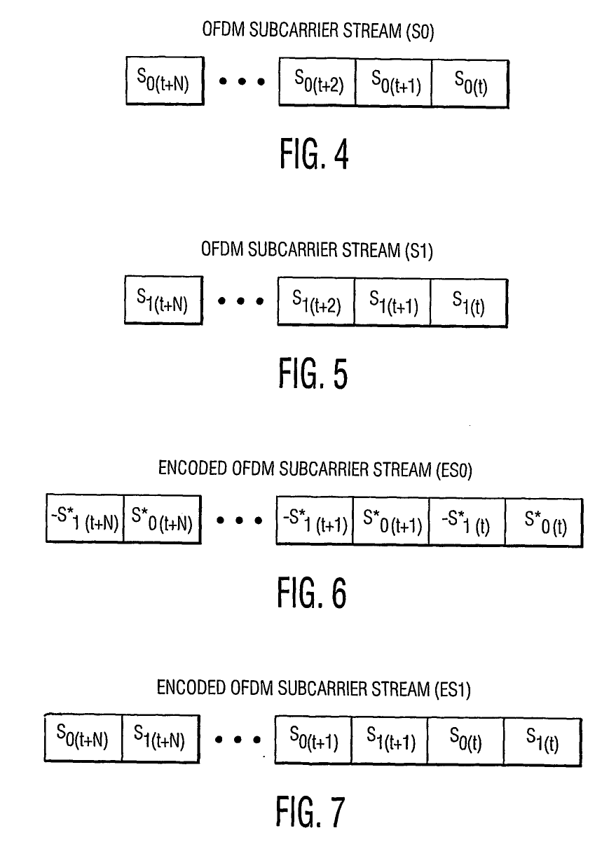

FIGS. 4 and 5 illustrate a pair of OFDM subcarrier streams in accordance with a first embodiment of the present invention;

FIGS. 6 and 7 illustrate a pair of encoded OFDM subcarrier streams in accordance with a first embodiment of the present invention;

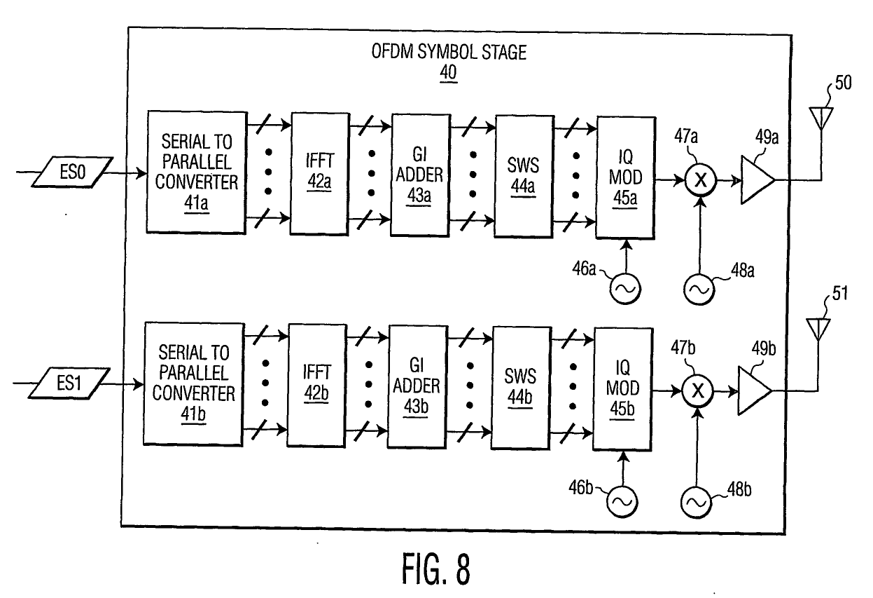

FIG. 8 illustrates a block diagram of an OFDM transmission stage of the OFDM system of FIG. 1 in accordance with one embodiment of the present invention; and

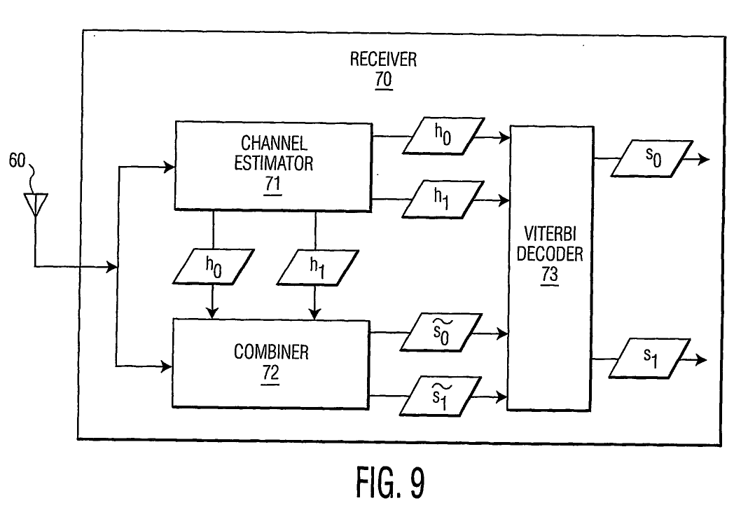

FIG. 9 illustrates a block diagram of a receiver of the OFDM system of FIG. 1 in accordance with one embodiment of the present invention.

### DESCRIPTION OF THE INVENTION

FIG. 1 illustrates an OFDM system 10 employing a transmitter 20, a pair of transmitter antennas 50 and 51, a receiver antenna 60, and a receiver 70 in implementing a OFDM transmission method of the present invention as represented by a flowchart 80 illustrated in FIG. 2. Upon receiving a data input signal d(t), a diversity encoding stage 30 of transmitter 20 performs stages S82 and S84 of flowchart 80, and an OFDM transmission stage 40 of transmitter 20 performs a stage S86 of flowchart 80. Upon receiving a pair of receiver signals r₀ and r₁, receiver 70 performs a stage S88 of flowchart 80. The various stages S82-S88 of flowchart 80 can be performed in series, or preferably in parallel.

FIG. 3 illustrates one embodiment of diversity encoding stage 30 for performing stages S82 and S84. The illustrated embodiment of diversity encoding stage 30 employs a scrambler 31, a FED code 32, and an interleaver/mapper 33 for splitting the input data signal d(t) into an OFDM subcarrier stream S0 and an OFDM subcarrier stream S1 during stage S82. In one embodiment, the splitting of the data input signal d(t) during stage S82 is based on an index, such as, for example, OFDM subcarrier stream S0 having odd symbols of data input signal d(t) as exemplarily illustrated in FIG. 4, and OFDM subcarrier stream S1 having even symbols of data input signal d(t) as exemplarily illustrated in FIG. 5.

The illustrated embodiment of diversity encoding stage 30 further employs a transmitter diversity encoder 34 for implementing a cross subcarrier transmitter diversity encoding of OFDM subcarrier stream S0 and OFDM subcarrier stream S1 to thereby generate an encoded OFDM subcarrier stream ES0 and an encoded subcarrier stream ES1 during stage S84. In one embodiment, the encoded OFDM subcarrier stream ES0 includes multiple symbol pairings with each symbol pairing having a complex conjugate symbol of OFDM subcarrier stream S0 and a negative complex conjugate symbol of OFDM subcarrier stream S1 within adjacent frequency bins as exemplarily illustrated in FIG. 6. Furthermore, the encoded OFDM subcarrier stream ES1 includes multiple symbol pairings with each symbol pairing having a symbol of OFDM subcarrier stream S0 and a symbol of OFDM subcarrier stream S1 within adjacent frequency bins as exemplarily illustrated in FIG. 7.

FIG. 8 illustrates one embodiment of OFDM transmission stage 40 for performing stage S86. The illustrated embodiment of transmission stage 40 employs a serial to parallel converter 41a, inverse fast Fourier transform (“IFFT”) 42a, a guard interval (“GI”) adder 43a, a SWS 44a, an IQ modulator 45a, a local oscillator 46a, a mixer 47a, a local oscillator 48a, and a radio frequency transmitter 49a for transforming the encoded OFDM subcarrier stream ES0 into a modulated transmission signal s₀ that is transmitted via transmitter antenna 50 to receiver antenna 60 (FIG. 1). The illustrated embodiment of transmission stage 40 further employs a serial to parallel converter 41b, an inverse fast Fourier transform 42b, a guard interval, an adder 43b, a SWS 44b, an IQ modulator 45b, a local oscillator 46b, a mixer 47b, a local oscillator 48b, and a radio frequency transmitter 49b for transforming the encoded OFDM subcarrier stream ES1 into a modulated transmission signal s₁ that is transmitted via transmitter antenna 51 to receiver antenna 60.

FIG. 9 illustrates one embodiment of receiver 70 for performing stage S88 upon receiving received symbols r₀ and r₁. In recovering the modulated transmitter signals s₀ and s₁ from received symbols r₀ and r₁, the illustrated embodiment of receiver 70 employs a channel estimator 71 for generating an estimation of the channels for transmitter antennas 50 and 51 in accordance with the following known equations [1]-[4], respectively:
h₀₀=a₀₀e^{jθ}^{₀₀} [1]
h₀₁=a₀₁e^{jθ}^{₀₁} [2]
h₁₀=a₁₀e^{jθ}^{₁₀} [3]
h₁₁=a₁₁e^{jθ}^{₁₁} [4]

where cahnnel estimation h₀₀ represents the channel for tranmsitter antenna 50 when a first sample is transmitted, channel estimation h₀₁ represents the channel for transmitter antenna 50 when a second sample is transmitted, channel estimation h₁₀ represents the channel for tranmsitter antenna 51 when a first sample is transmitted, and channel estimation h₁₁ represents the channel for transmitter antenna 51 when a second sample is transmitted.

The illustrated embodiment of receiver 70 employs a combiner 72 for generating an estimated transmitter signal \tilde{S}₀ and an estimated transmitter signal \tilde{S}₁ in accordance with the following equations [5]-[8], respectively, based on the assumption that each subcarrier experiences the flat fading channel:

$$\begin{matrix}{r}_{0} = r ( t ) = {h}_{0 j} {s}_{0} + {h}_{1 j} {s}_{1} + {n}_{0} & [ 5 ] \\ {r}_{1} = r ( t + 1 ) = - {h}_{0 j} {s}_{1}^{*} + {h}_{1 j} {s}_{0}^{*} + {n}_{1} & [ 6 ] \\ {\tilde{s}}_{0} = \frac{{h}_{01}^{*} {r}_{0} + {h}_{10}^{*} {r}_{1}^{*}}{{h}_{00} {h}_{01}^{*} + {h}_{10} {h}_{11}^{*}} + noise 1 & [ 7 ] \\ {\tilde{s}}_{1} = \frac{{h}_{11}^{*} {r}_{0} + {h}_{00}^{*} {r}_{1}^{*}}{{h}_{00} {h}_{01}^{*} + {h}_{10} {h}_{11}^{*}} + noise 2 & [ 8 ]\end{matrix}$$

where n₀ represents noise and interferences for tranmistter antenna 50, and n₁ represents noise and interferences for tranmistter antenna 51.

The illustrated embodiment of receiver 70 employs a conventional maximum likelihood detector 73 in the form of a Viterbi decoder for deriving the modulated transmitter signals s₀ and s₁ from estimated transmitter signals \tilde{S}₀ and \tilde{S}₁, respectively.

It is important to note that FIGS. 1-9 illustrate specific applications and embodiments of the present invention, and is not intended to limit the scope of the present disclosure or claims to that which is presented therein. Upon reading the specification and reviewing the drawings hereof, it will become immediately obvious to those skilled in the art that myriad other embodiments of the present invention are possible, and that such embodiments are contemplated and fall within the scope of the presently claimed invention.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. An OFDM transmitter (20), comprising:
a diversity encoding stage (30) including means for splitting a data input signal into a first OFDM subcarrier stream (S0) and a second OFDM subcarrier stream (S1), said diversity encoding stage (30) further operable to implement a cross subcarrier transmitter diversity encoding of the first OFDM subcarrier stream (S0) and the second OFDM subcarrier stream (S1) to thereby generate a first encoded OFDM subcarrier stream (ES0) and a second encoded OFDM subcarrier stream (ES1); and
an OFDM symbol stage (40) including means for transforming the first encoded OFDM subcarrier stream (ES0) into a first modulated transmitter signal (s₀), said OFDM symbol stage (40) operable to transform the second encoded OFDM subcarrier stream (ES1) into a second modulated transmitter signal (s₁).

2. The OFDM system of claim 1, wherein said first OFDM subcarrier stream (S0) includes odd symbols of the data input signal.

3. The OFDM transmitter (20) of claim 1, wherein said second OFDM subcarrier stream (S1) includes even symbols of the data input signal.

4. The OFDM transmitter (20) of claim 1, wherein said first encoded OFDM subcarrier stream (ES0) includes multiple symbol pairings, each symbol pairing having a complex conjugate symbol of said first OFDM subcarrier stream (S0) and a negative complex conjugate symbol of said second OFDM subcarrier stream (S1) over adjacent frequency bins.

5. The OFDM transmitter (20) of claim 1, wherein said second encoded OFDM subcarrier stream (ES1) includes multiple symbol pairings, each symbol pairing having a symbol of said second OFDM subcarrier stream (S0) and a symbol of said second OFDM subcarrier stream (S1) over adjacent frequency bins.

6. A method (80) of operating an OFDM transmitter (20), said method (80) comprising:
(S82) splitting a data input signal into a first OFDM subcarrier stream (S0) and a second OFDM subcarrier stream (S1); and
(S84) implementing a cross subcarrier transmitter diversity encoding of the first OFDM subcarrier stream (S0) and the second OFDM subcarrier stream (S1) to thereby generate a first encoded OFDM subcarrier stream (ES0) and a second encoded OFDM subcarrier stream (ES1).

7. The method (80) of claim 6, further comprising:
(S86) transforming the first encoded OFDM subcarrier stream (ES0) into a first modulated transmitter signal (s₀); and
(S86) transforming the second encoded OFDM subcarrier stream (ES1) into a second modulated transmitter signal (s₁).
